(19) United States
(12) Patent Application Publication
(10) Pub. No.: US 2006/0035488 A1
(43) Pub. Date: Feb. 16, 2006

(54) Connector with conductors exposed to exterior air to facilitate heat removal

(75) Inventors: Frank E. Bosco, Poughkeepsie, NY (US); Daniel Douriet, Round Rock, TX (US); Andreas Huber, Holzgerlingen (DE)

Correspondence Address: DILLON & YUDELL LLP, 8911 N. CAPITAL OF TEXAS HWY.,, SUITE 2110, AUSTIN, TX, 78759, US

(73) Assignee: International Business Machines Corp., Armonk, NY (US)

(21) Appl. No.: 10/916,973

(22) Filed: Aug. 12, 2004

(51) Int. Cl. H01R 12/00

(52) U.S. Cl. 439/74

(57) ABSTRACT

A power connector that uses ambient air to cool exposed power conductors through the use of either passive or forced air convection. The power conductors in the power connector are distributed for maximum contact with the cooling air. The power connector's housing is designed to cause maximum air flow across and/or against the power conductors.

### BACKGROUND OF THE INVENTION

1. Technical Field

The present invention relates in general to the field of electronics, and in particular to power connectors. More particularly, the present invention relates to a method and system for conducting heat away from a power connector by exposing electrical conductors in the power connector to heat-removing ambient air.

2. Description of the Related Art

In a modem computer, one source of heat inside the computer is a power circuit. The power circuit includes a power source, which supplies power to a power connector. The power connector is composed of a male power connector coupled with a female power connector. The female power connector has receptacles on one side for mating with the male power connector, and power supplying pins, on another side, that are soldered into holes in a printed circuit board. The printed circuit board provides pathways for power from the power supplying pins to multiple devices on the printed circuit board.

As electrical current load through the power connector increases (as the power connector carries more current), a significant temperature rise in the power connector typically occurs. Power connectors are thus rated according to the amount of current they can carry without heating up more than 30° C. For example, a power connector is rated at 500 A if its temperature rises no more than 30° C. when carrying 500 A. Therefore, if a power connector rises more than 30° C. when carrying 500 A, then a larger and more expensive power connector must be used to handle the current.

A typical prior art power connector is shown in FIG. 1. A power connector 100 is made up of a male power connector 102 (shown transparently) and a female power connector 104. Female power connector 104 has a housing 106, inside of which are multiple conductors 108 used for power distribution. Each conductor 108 is composed of a power plate 110 and multiple pins 112 that extend from an end of the power plate 110. Connected to each of the power plates 110 is one of power lines 114, which feed from male power connector 102. The pins 112 of conductors 108 plug into holes (not shown) in a printed circuit board 116, where they are typically soldered for a permanent connection.

Although a top 118, sides 120a-b, and end 122 are shown removed in order to see conductors 108, typically housing 106 is either solid plastic (plastic being between each of the conductors 108) or else housing 106 forms a box that encloses conductors 108. In either configuration, heat generated by conductors 108 is trapped inside housing 106.

Current connector technologies are designed to meet electrical and mechanical requirements, but these current technologies are not optimized to dissipate away heat that is generated by the conductors. The current solutions to overheating connectors are to 1) use larger connectors, 2) reduce contact resistance between the connectors and receptacles using conductor materials, such as silver, in connector pins, or 3) install oversized cooling fans, which consume additional power, in a computer using the connectors. All such solutions are unduly expensive.

What is needed, therefore, is an inexpensive connector design that allows for the efficient removal of heat generated by its conductors, thus limiting temperature rise, improving reliability, and increasing electrical current load capacity of the connector.

### SUMMARY OF THE INVENTION

The present invention is therefore directed to a power connector that uses ambient air to cool exposed power conductors through the use of either passive or forced air convection. The power conductors in the power connector are elongated and distributed for maximum contact with the cooling air. The power connector's housing is designed to cause maximum air flow across and/or against the power conductors.

The above, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a prior art power connector having a design that traps heat from internal power distributing conductors;

FIGS. 2a-c illustrate an inventive power connector having extended power distributing conductors that are exposed to ambient air for improved cooling of the power connector;

FIG. 3 depicts a novel power connector that is mounted on but offset away from a printed circuit board to allow for cooling air flow under the power connector;

FIG. 4 illustrates a power connector having side openings that permits cross-flow air ventilation of the power distributing conductors inside the power connector; and

FIG. 5 depicts a power connector having an adjoined cooling fan to move air though air channels inside the power connector.

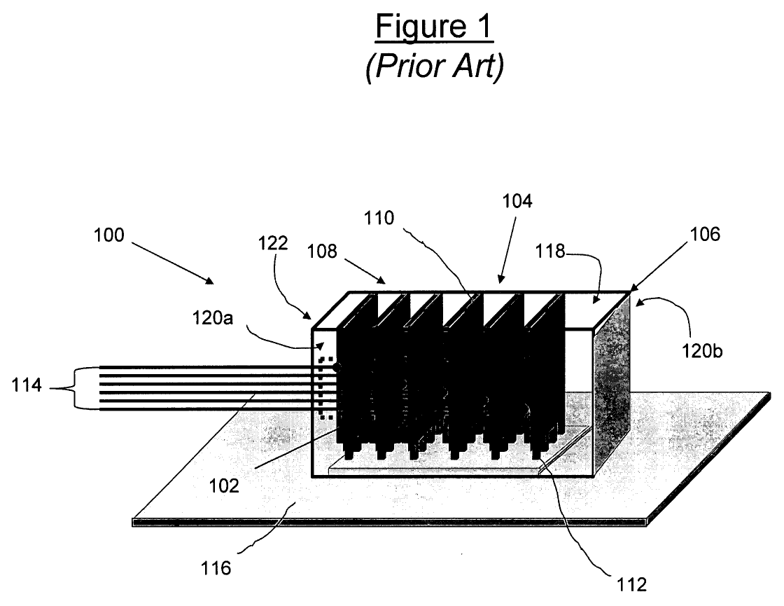

### DETAILED DESCRIPTION OF A PREFERRED EMBODIMENT

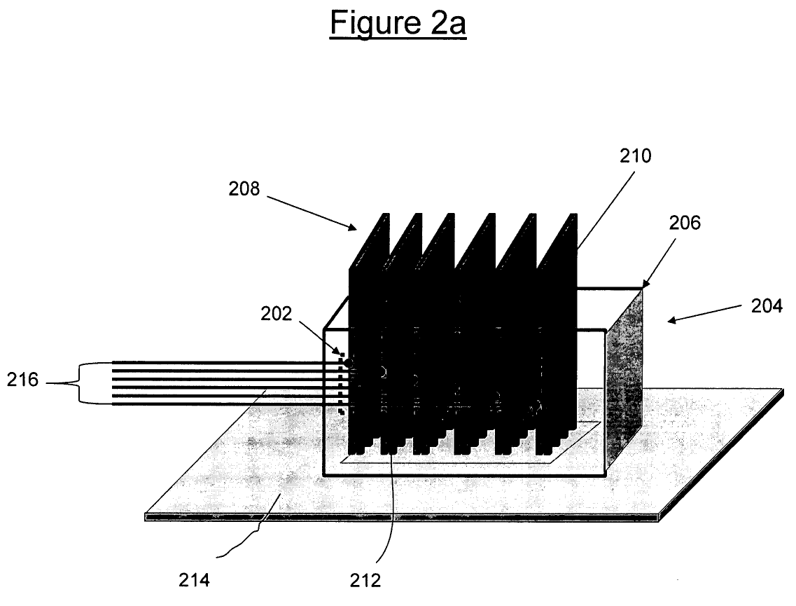

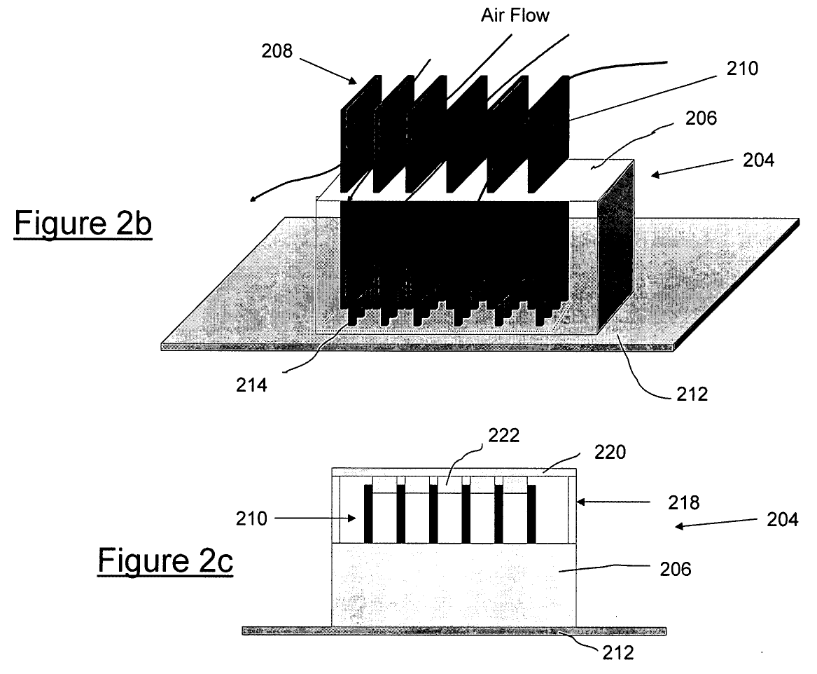

With reference now to FIGS. 2a-c, there is depicted a novel power connector 200, which is composed of a male power connector 202 (shown as being transparent) coupled to a female power connector 204. Female power connector 204 is composed of a conductor housing 206, which houses multiple conductors 208. Each conductor 208 has a power plate 210 that has an end from which multiple pins 212 extend. Pins 212 mate with holes (not shown) in a circuit board 214, which supplies pathways to other components (not shown), preferably those components that are mounted on circuit board 214. Each power plate 210 is connected to one of power supplying power lines 216, which feed into male power connector 202.

While shown as being transparent in FIG. 2a, in order to show the portions of conductors 208 that are internal to conductor housing 206, note that conductor housing 206 may either be solid (having plastic or a similar material between power plates 210), or else conductor housing 206 may be a box that encloses a portion of conductors 208 and the space between them. Either way, note that a portion of all of the power plates 210 extend out of conductor housing 206, as is shown (without male power connector 202 for clarity) in FIG. 2b. Thus, cooling ambient air is allowed to flow between the exposed portions of the power plates 210 as shown.

As seen in FIG. 2c, a protector 218 may be added to conductor housing 206. Protector 218 includes a protective top 220, to which are attached spreaders 222, which fit between the power plates 210. Protector 218 prevents the exposed portions of power plates 210 from shorting out against each other, or from shorting out against a tool or component (not shown) within a computer that may inadvertently strike against one of the power plates 210.

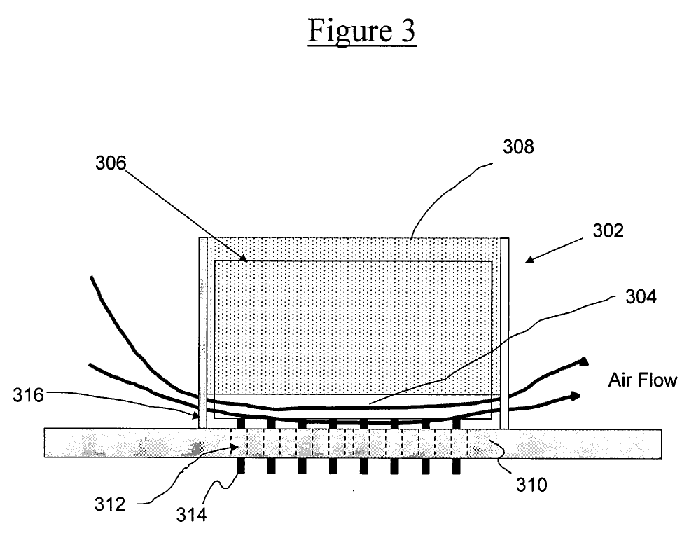

With reference now to FIG. 3, an alternate embodiment of a power connector is shown, showing a female connector but without showing external power supplying power cables or a male connector for purposes of clarity. In a connector 302, exposed portions of power plates 304 of conductors 306 are below a conductor housing 308. Thus, air flow between the top of a circuit board 310 (preferably a portion of a printed circuit board having holes 312 for receiving pins 314 as shown) and the bottom of conductor housing 308 passes across and cools the exposed areas of power plates 304 as shown. The spacing between conductor housing 308 and circuit board 310 is maintained by legs 316. Such spacing is preferably between 3 and 5 millimeters to afford optimum air flow. Alternatively, this spacing is maintained by a tapering in pins 314 that permits only limited downward travel through holes 312 in circuit board 310. A main benefit to the system shown in FIG. 3 is that since the narrowing of current paths through pins 314 results in a hotter region in conductors 306 than found in power plates 304, directly exposing pins 314 and the adjacent portions of power plates 304 to ambient air flow affords maximum efficiency in heat removal.

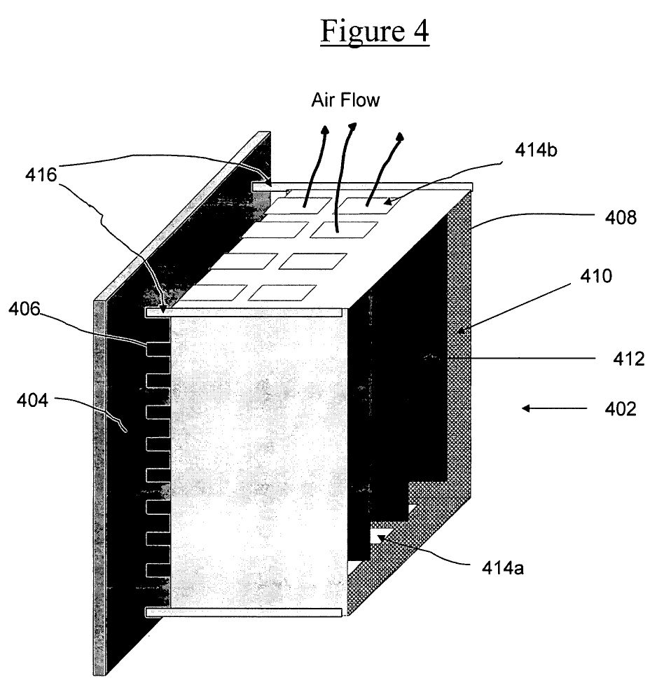

Referring now to FIG. 4, there is illustrated another preferred embodiment of a female power connector, depicted as connector 402, which is coupled to circuit board 404 via pins 406 inserted into holes (not shown) in circuit board 404. Connector 402, which is a female connector mated with a (not shown) male connector having incoming power lines, is composed of a conductor housing 408, within which are conductors 410. Each conductor 410 has a plate 412 from which pins 406 extend. Note that conductor housing 408 is a box, and thus leaves air space between plates 412. To provide additional cooling, conductor housing 408 has openings 414 on the sides. This arrangement is particularly beneficial if circuit board 404 is oriented vertically, such that the air flow moves upwards through the conductor housing 408 and out the top openings 414. Conductor housing 408 may have an exposed open side as shown, or the depicted open side may be enclosed with either a solid or an air permeable structure (not shown).

The conductor housing 408 shown in FIG. 4 is depicted as an open box. In an alternate preferred embodiment, conductor housing 408 may be a solid structure (with plastic or other material between plates 412) except for passageways going from openings 414a (air passage entrances) on one side to openings 414b (air passage exits) on another (preferably opposite) side of conductor housing 408. These passageways can be molded during the construction of conductor housing 408, or they can be drilled through conductor housing 408 (taking care not to drill into the plates 412).

In a preferred embodiment, a spacing of 3 to 5 millimeters is maintained between conductor housing 408 and circuit board 404 by legs 416. This spacing allows additional cooling of pins 406 and the exposed portions of power plates 412.

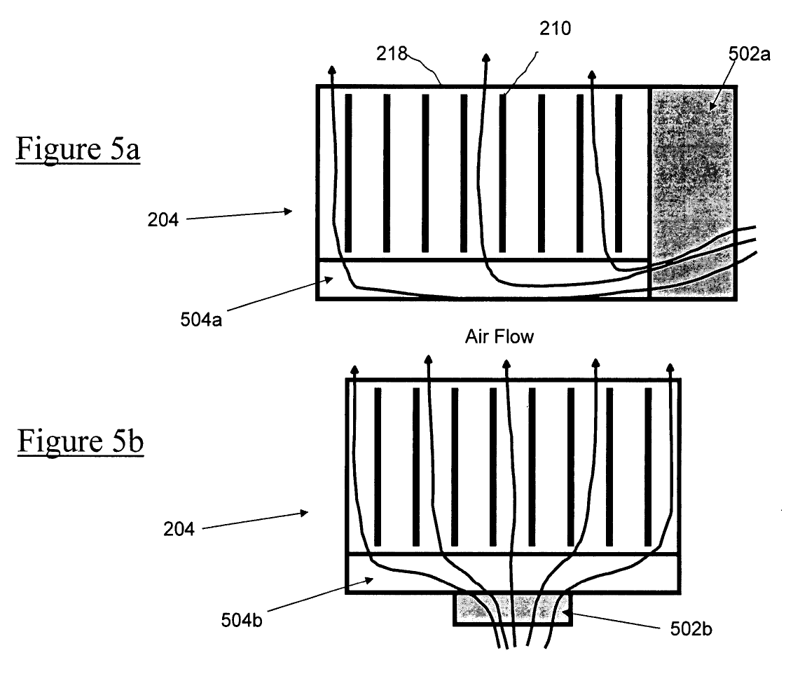

While the connectors have been shown as relying on passive air flow, or active air flow from an unidentified fan associated in or near the computer system in which the connector is located, alternatively a fan can be mounted directly to the power connector, as shown in FIGS. 5a-b. Using a power connector such as female power connector 204 having a protector 218 as shown in FIG. 2c, a cooling fan housing 502, containing one or more fans (not shown), can be mounted directly against female power connector 204. Note that female power connector 204 also has an air channel 504, which directs air past and/or against power plates 210. It is preferable to construct air channel 504 in a manner that causes a maximum amount of airflow to strike directly against (perpendicular to) the power plates 210, thus causing air impingement against the power plates 210 for improved heat transfer.

Although the invention has been particularly shown and described with reference to a preferred embodiment, it will be understood by those skilled in the art that various changes in form and detail may be made therein without departing from the spirit and scope of the invention. For example, the present invention may be useful with any Connector device, not limited to only power connectors, that generates excessive unwanted heat. An example of such a device is a signal connector for information signals. Since resistivity of a metal is directly proportional to the temperature of the metal, a higher temperature in a connector results in additional electrical resistance, and thus greater signal loss. By keeping the signal connector cool, less information is lost in the signal being transmitted.

Similarly, while the power connectors depicted have been shown as terminators for power cables, the power connectors described by the present invention may alternatively be part of adapter boards or other electronic components requiring connectors, including power connectors.

Further, although terms such as “above” and “beneath” may have been used to describe the spatial orientation and movement of different components, such terms are used generically, and the present invention as described and claimed is to include orientations so generally described, but not limited to such “up/down” definitions. Similarly, terms such as “male” and “female” are used to describe a mating relationship between components, and such terms should not be construed to strictly limit the physical structure of these components.

1. A connector comprising:
a conductor housing;
a plurality of conductors oriented partially within the conductor housing, such that each conductor is partially exposed to an exterior of the conductor housing for direct air cooling from air circulating around the exterior of the conductor housing, each conductor being composed of a plate and a plurality of connector pins extending from an end of the plate; and
at least one offset on the conductor housing that provides a spacing between the conductor housing and a circuit board when the connector and the circuit board are fully mated, such that a portion of the pins is oriented within the spacing between the conductor housing and the circuit board when the connector and the circuit board are fully mated,

2. The connector of claim 1, wherein a portion of the plate is oriented into a void, said void being exposed to the air circulating around the exterior of the conductor housing to allow exterior air to circulate about and to cool the plates, within the spacing between the conductor housing and the circuit board when the connector and the circuit board are fully mated.

3. The connector of claim 1, wherein the conductors conduct power.

4. The connector of claim 1, wherein the conductors trait information signals.

5. The connector of claim 1, wherein the conductor housing further comprises a plurality of air passages between the plates oriented with the conductor housing, each air passage having an air passage entrance into and an air passage exit from an interior of the conductor housing and the exterior of the conductor housing to allow air flow from the exterior of the conductor housing to the plates.

6. The connector of claim 5, further comprising a fan housing coupled to the conductor housing, the fan housing having one or more fans for moving air through the plurality of air passages.

7. The connector of claim 1, wherein the spacing is between 3 and 5 millimeters to permit an optimum cooling air flow against the exposed pins and plates.

8. A system comprising:
a connector composed of:
a conductor housing;
a plurality of conductors oriented partially within the conductor housing, such that each conductor is partially exposed to an exterior of the conductor housing for direct air cooling from air circulating around the exterior of the conductor housing, each conductor being composed of a plate and a plurality of connector pins extending from an end of the plate; and
at least one offset on the conductor housing tat provides a spacing between the conductor housing and a circuit board when tee connector and the circuit board are fully mated, such that a portion of the pins is oriented within the spacing between the conductor housing and the circuit board when the connector and the circuit board are fully mated.

9. The system of claim 8, wherein a portion of the plate is oriented into a void, said void being exposed to the air circulating around the exterior of the conductor housing to allow exterior air to circulate about and to cool the plates, within the spacing between the conductor housing and the circuit board when the connector and the circuit board are fully mated.

10. The system of claim 8, wherein the conductors conduct power.

11. The system of claim 8, wherein the conductors transit information signals.

12. The system of claim 8, wherein the conductor housing further comprises a plurality of air passages between an interior of the plates oriented with the conductor housing and the exterior of the conductor housing to allow air flow from the interior of the conductor housing to the plates.

13. The system of claim 12, further comprising a fan housing coupled to the conductor housing, the fan housing having one or more fans for moving air through the plurality of air passages.

14. The system of claim 8, wherein the system is a computer.

15. A connector comprising:
a conductor housing; and
a plurality of conductors oriented partially within the conductor housing, such that each conductor is partially exposed to an exterior of the conductor housing for direct air cooling from air circulating around the exterior of the conductor housing, each of the conductors being composed of a plate and a plurality of pins extending from one end of the plate, wherein the plurality of pins extend from a first side of the conductor housing to mate with holes in a circuit board, and wherein a first portion of each plate extends away from a second side of the conductor housing, such that the first portion of the plates are outside the conductor housing and a second portion of the plates are within the conductor housing.

16. The connector of claim 15, wherein the conductor housing further comprises a protector above the exposed first portions of each plate, the protector having a top, a first side and second side that support the top, the first and second sides being oriented parallel with the plates, and a first opening and a second opening oriented into a void, said void being exposed to the air circulating around the exterior of the conductor housing to allow exterior air to circulate about and to cool the plates, to permit unrestricted air-flow through passageways between the plates.

17. The connector of claim 16, wherein the top further comprises spacer that separate the plates.

18. The connector of claim 15, further comprising a fan housing coupled to the conductor housing, the fan housing containing at least one fan for forcing air past the exposed first portion of each plate.

19. The connector of claim 15, further comprising a plurality of legs on the conductor housing, the legs providing a spacing between the conductor housing and a circuit board when the conductor housing and the circuit board are fully mated, such that the pins are exposed to a cooling air flow.

20. The computer system comprising:
a connector composed of:
a conductor housing; and
a plurality of conductors oriented partially within the conductor housing, such that each conductor is partially exposed to an exterior of the conductor housing for direct air cooling from air circulating around the exterior of the conductor housing, each of the conductors being composed of a plate and a plurality of pins extending from one end of the plate, wherein the plurality of pins extend from a first side of the conductor housing to mate with holes in a circuit board, and wherein a first portion of each plate extends away from a second side of the conductor housing, such that the first portion of the plates are outside the conductor housing and a second portion of the plates are within the conductor housing.
